(19) United States
(12) Patent Application Publication
(10) Pub. No.: US 2013/0261817 A1
(43) Pub. Date: Oct. 3, 2013

(54) PRODUCING AND SUPPLYING STABLE POWER FROM RENEWABLE RESOURCES

(71) Applicants: James Detmers, Folsom, CA (US); John Redding, Mendocino, CA (US); Eric Whitley, Folsom, CA (US)

(72) Inventors: James Detmers, Folsom, CA (US); John Redding, Mendocino, CA (US); Eric Whitley, Folsom, CA (US)

(21) Appl. No.: 13/438,769

(22) Filed: Apr. 3, 2012

(51) Int. Cl. G06F 1/26

(52) U.S. Cl. 700/287

(57) ABSTRACT

Techniques are provided for a unified power production system that produces and supplies a stable power from renewable resources coupled with a firming resource. The power production system includes a management system that dispatches a firming resource operatively coupled to the power production system whose power output is combined with the power output from the renewable resources to produce a stable output to a grid operator. The management system monitors and maximizes the renewable resource production and minimizes the operation of the fossil-fuel-consuming firming resource.

### FIELD OF THE INVENTION

Embodiments of the present invention generally relate to power generation from renewable resources. In particular, systems and methods are provided for producing and supplying predictable and stable power using renewable resources.

### BACKGROUND OF THE INVENTION

Energy production from renewable resources, such as wind and solar, are prone to unpredictability and fluctuation, due to the unpredictable nature of wind and sunlight. Grid operators, such as the California Independent System Operator (ISO), require generator operators to commit to a day-ahead schedule of hourly power generating output. The commitments allow predictability so that electricity can be sold in a day-ahead market, which closes one day before the trade date, and so that the electricity can be delivered on the grid as scheduled. Grid operators balance deviations from the schedule with Ancillary Services and a real-time market, which is a spot market to produce energy to the grid to balance instantaneous demand, and to reduce or increase supply if production or demand fall or rise unexpectedly. It is desirable to minimize such grid disturbances to lessen the need for a grid operator to balance with Ancillary Services and the real-time market.

Schedules are updated by an hour-ahead scheduling process which produces schedules for a short-term commitment by generator operators. The grid operator dispatches in the short term to dispatch for accounting for energy that deviates from the schedule, and runs automatically and issues dispatches every 5 minutes for a single 5-minute interval during the actual operating hour.

Generator operators deviating from the final schedule are subject to imbalance energy charges and possible uninstructed deviation penalties which are assessed for deviations from the committed schedule outside of a certain tolerance. Due to the unpredictability of the production of renewable resources such as wind- and solar-powered resources, it is desirable to lessen the deviations caused by the fluctuations in the produced electrical output from renewable resource to reduce financial penalties levied on the generator operator.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Preferred embodiments of the invention are illustrated by way of example, and not by way of limitation, in the figures of the accompanying drawings and in which like reference numerals refer to similar elements and in which:

FIG. 1 is a block diagram that shows a configuration for a system for producing stable power using renewable resources, according to some embodiments of the invention.

FIG. 2 is a diagram that illustrates the time sequence of the steps for a process for producing stable power using renewable resource, according to some embodiments of the invention.

FIG. 3 is a graph illustrating an example of power output generated from a renewable resource according to some embodiments of the invention.

FIG. 4 is a graph illustrating an example of power output generated from a firming generating resource as directed by a management system, which when combined with power output generated from a renewable resource, results in a stable combined output according to some embodiments of the invention.

FIG. 5 is a graph illustrating an example of the combined power production using a renewable resource in combination with a firming resource as managed by a management system, according to one embodiment of the invention.

FIG. 6 is a block diagram illustrating the various modules of a power production management system according to some embodiments of the invention.

FIG. 7 is a block diagram illustrating an example of a computer system on which embodiments of the invention may be implemented.

### DETAILED DESCRIPTION

In the following description, for the purposes of explanation, numerous specific details are set forth in order to provide a thorough understanding of the present embodiments of the invention. It will be apparent, however, that the present embodiments of the invention may be practiced without these specific details. In other instances, well-known structures and devices are shown in block diagram form in order to avoid unnecessarily obscuring the present embodiments of the invention.

Techniques are provided to produce and supply stable power from a power production system having renewable resources.

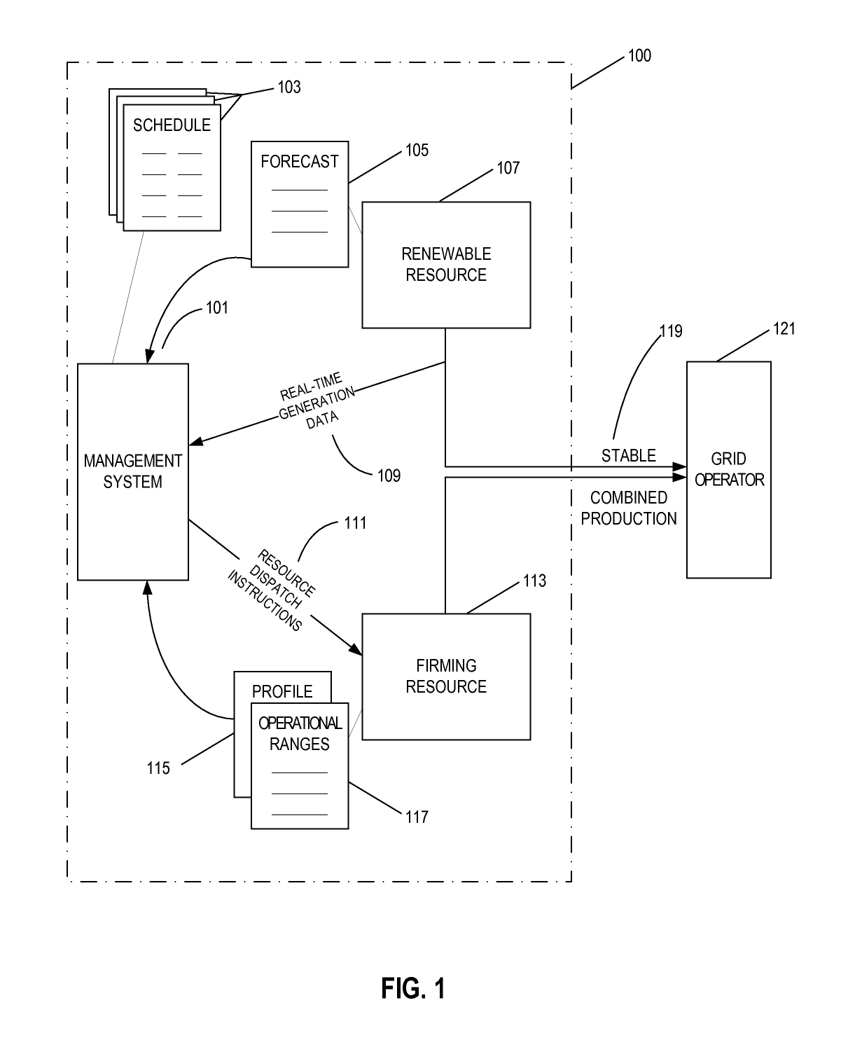

FIG. 1 shows one embodiment of the power production system 100 for producing stable power including power generated from renewable resources. Power production system 100 comprises several components that function together in a unified manner to produce steady combined production output 119 to grid operator 121.

Management system 101 receives one or more forecasts 105 for generation for the renewable resource or resources 107. Based on forecasts 105, management system 101 generates one or more schedules 103. However, in some embodiments, schedules 103 are predefined by a third party. Schedules 103 include targets for power generation production output from power production system 100 to the grid operator 121 for each time interval over a particular duration, which may include forecasted deviation quantities. Examples of schedules 103 include schedules for a certain frequency of time and for a certain duration from the time the schedule is generated, the durations and frequency ranging from 24 hours to seconds ahead. In some embodiments, certain schedules 103 are provided to grid operator 121 in advance of the periods covered by the schedules, and are a financial and physical commitment by power production system 100 to produce the amount of power specified as planned on the schedule over the prescribed period of time. Schedules 103 are also used by management system 101 to guide power production system 100 to produce an amount of power close to that specified on the schedule. In some embodiments, schedules 103 include minute-by-minute output schedules, hourly output schedules, or outputs for any combination of two or more intervals.

One or more schedules 103 are generated in part based on renewable supply forecasts 105 for renewable resource 107. In some embodiments, renewable resource 107 comprises one or more wind-powered resources. In some embodiments, renewable resource 107 comprises one or more solar-powered resources, or arrays. In still other embodiments, renewable resource 107 comprises any combination of resources powered by renewable sources, including by not limited to hydropower, geothermal power, tidal power, or other renewable supply resource. Supply schedules are generated repeatedly for time intervals of a certain duration and frequency. Demand schedules are generated in part based on forecasted load or demand on the power system received from the grid operator 121.

Forecasts 105 comprise predictions and estimations of the status of the renewable resource 107 during the specified time intervals over the durations on schedules 103. For example, forecast 105 may predict that wind conditions will be 25 miles-per-hour winds at the site of the wind-powered resources at 11:00-11:05 A.M., and 5 miles-per-hour winds at 3:00-3:30 P.M. In some embodiments, forecasts 105 are based on historical data patterns for the renewable source, including but not limited to historical meteorological data and historical power generation data. In some embodiments, forecasts 105 comprise predictions and estimations of power to be generated from renewable resource 107 during a specified time interval.

Management system 101 also receives profile 115 and operational ranges 117 for firming resource 113. In some embodiments, firming resource 113 is a resource for supplementing the power production of another resource in a power production system. Firming resource 113 comprises one or more conventional resources using conventional techniques for generating power, including any predictable and dispatchable resource. Such conventional resources include but are not limited to reciprocating engines using fuels such as natural gas, diesel, or biofuels, other fossil fuel generators, hydroelectric power, electrical storage facilities, demand response systems, turbines driven by steam produced by heat energy released from fuel, battery power, and other predictable and dispatchable resources. In some embodiments, firming resource 113 is dedicated to being dispatched by management system 101 to operate in conjunction with renewable resource 107. In some embodiments, firming resource 113 is operatively coupled with renewable resource 107 by management system 101.

Profile 115 and operational ranges 117 includes information about firming resource 113 that describes its characteristics. Such characteristics are considered by management system 101 to determine optimal limits for dispatching firming resource 113. Profile 115 includes characteristics affecting firming resource 113 such as price of natural gas, the price of the market/Balancing Authority economic dispatch point (Hourly System Lambda), air emission permit limits (NOX, SOX CO2, PM10), timing and cost of cycling firming resource 113 off and on, operational deadbands and forbidden operating points of firming resource 113, ramp rates for increasing and decreasing supply, generator fuel supply limitations and restrictions. Operational ranges 117 include capacity and supply characteristics, additional operational deadband values to minimize unwanted oscillation or repeated activation-deactivation cycles of firming resource 113, time-delay values and directional turn-about values to determine responsiveness and capacity of firming resource 113, and capacity values to determine planned and maximum generating capacity of firming resource 113. Profile 115 and operational ranges 117 are used by management system 101 to generate resource dispatch instructions 111 for a fast- or slow-acting firming resource 113. In some embodiments, dispatch instructions 111 include frequency regulating features that are a design of firming resource 113 and augmented by management system 101 to compensate for power system characteristics not provided by renewable supply source 113. Examples of such power system characteristics include but are not limited to additional governor response and inertial response, which are responding to system frequency deviations outside of normal tolerances.

In some embodiments, schedules 103 are additionally based on profile 115 and operational ranges 117 to estimate the power generation output from power production system 100, which includes coupled output from both renewable resource 107 and firming resource 113 to the grid operator 121. In some embodiments, schedules 103 are determined for minimizing energy consumption of firming resource 113 to minimize its use of non-renewable fuels and maximize renewable deliveries where possible. For example, firming resource 113 produces as close to the minimum amount of power necessary for power production system 100 to produce a stable combined output from firming resource 113 and renewable resource 107.

Based on one or more of schedules 103, forecast 105, profile 115 and operational ranges 117, management system 101 sends resource dispatch instructions 111 to firming resource 113. In some embodiments, the management system 101 determines a central value for power production above or below which firming resource 113 can increase or decrease production respectively. Resource dispatch instructions 111 include instructions to firming resource 113 to generate power at the central value, or at values above or below central value, depending on the real-time generation data 109 received from renewable resource 107 by the management system 101. Resource dispatch instructions 111 to firming resource 113 are set such that combined production output 119 from both renewable resource 107 and firming resource 113 is a more predictable and/or stable combined production output 119 to grid operator 121 to minimize deviations from the scheduled commitment to the grid operator. The more predictable and/or stable combined production output 119 allows grid operator 121 to better plan its utilization of the transmission grid infrastructure. In some embodiments, firming resource 113 is minimally dispatched such that when renewable resource 107 is generating power at maximum capacity, dispatch levels to firming resource 113 are correspondingly decreased to minimum operation level while producing stable combined production output 119 for grid operator 121. In some embodiments, a stable combined production output 119 includes output that is steadier than the output from renewable resource 107 alone.

Management system 101 receives real-time generation data 109 from renewable resource 107. In some embodiments, based on profile 115 and operational ranges 117 of firming resource 113, management system 101 sends resource dispatch instructions 111 to firming resource 113 at short intervals based on the real-time generation data 109.

In some embodiments, management system 101 uses a controller and control-loop feedback techniques to control firming resource 113 based on real-time generation data 109. Further, management system 101 considers one or more of schedule 103, forecast 105, profile 115 and operational ranges 117 for producing resource dispatch instructions 111 for optimal use of firming resource 113. Examples of control-loop feedback techniques include proportional-integral derivative (PID) controllers and tuning processes. In some embodiments, the set points used by management system 101 for a controller correspond with power production output values as set forth in one or more of schedules 103. In some embodiments, for example, where renewable resource 107 is a solar-powered resource, the controller uses an exponential moving average to determine the dispatch level for firming resource 113.

In some embodiments, firming resource 113 is a fast-acting resource capable of responding quickly to any new dispatch level in the resource dispatch instructions 111. In some embodiments, the output of firming resource 113 can change quickly in response to real-time generation data 109 received at small intervals from renewable resource 107. In some embodiments, intervals are as small as one second, or longer. In some embodiments, management system 101 sends updated resource dispatch instructions 111 to adjust the output of firming resource 113 at small intervals. For example, management system 101 sends resource dispatch instructions 111 to firming resource 113 at intervals shorter than 10 seconds. In some examples, the interval is 5 seconds.

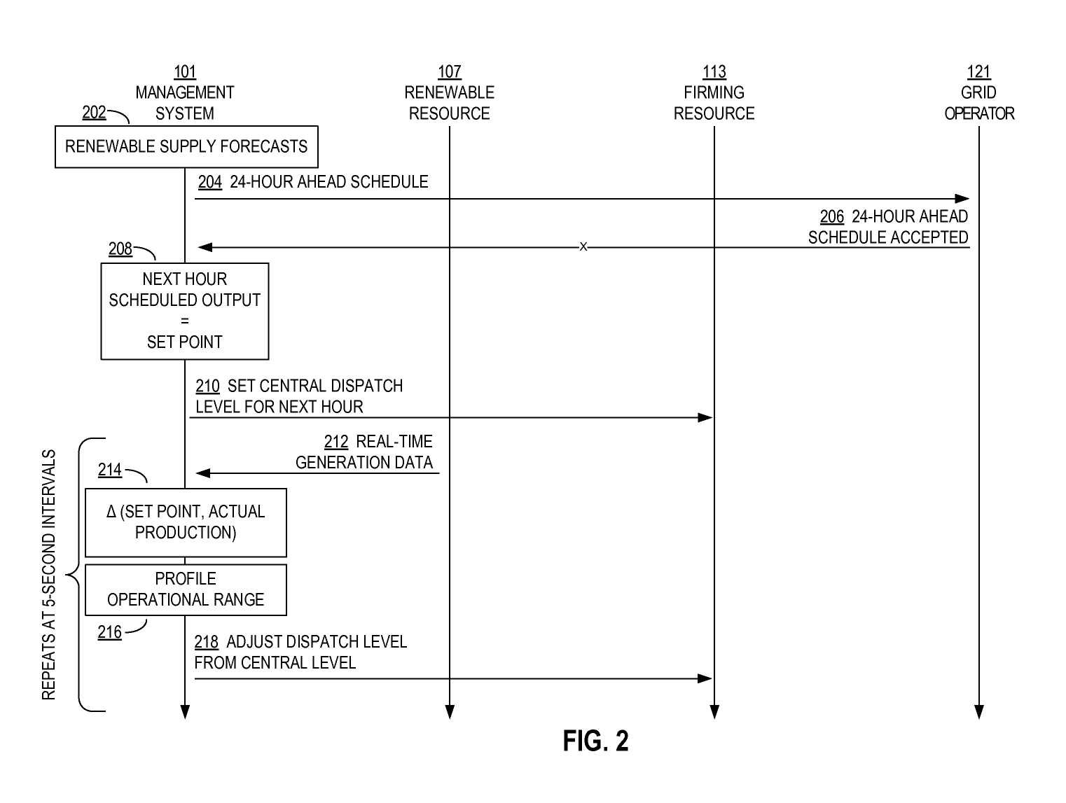

FIG. 2 is a sequence diagram that illustrates the sequence of steps leading to providing real-time dispatch directives for a firming resource resulting in the production of stable power using a renewable resource according to one embodiment of the invention. In the following description, examples are shown and described herein. However, it will be understood that numerous changes, variations, and substitutions may occur to those skilled in the art without departing from the spirit of the invention.

At step 202, occurring before the deadline of the time period for submitting a schedule to grid operator 121, management system 101 processes renewable supply forecasts for renewable resource 107. Management system 101 may also receive a forecasted load or demand on the power system from the grid operator 121. Based in part on the forecasts, at step 204, management system 101 produces and sends a schedule to grid operator 121. While shown in this example as a 24-hour ahead schedule, it is understood that the time period covered by the schedule can be for any duration, including any time period required by the grid operator for schedules. At step 206, management system 101 receives an accepted schedule, or data indicating that the schedule as sent had been accepted.

In some embodiments, as illustrated in FIG. 2, the schedule accepted represents a commitment to a total power delivery for each hour, as well to the stable delivery of the power within the hour. For example, a 110 MWh schedule commits the generator operator to deliver 110 MW for the hour, and to deliver power at a stable level (e.g., with a standard deviation as close to zero from 110 MW for each minute within the hour). It is desirable to produce power to meet both the targeted total delivery and the targeted stable rate of delivery. In some embodiments, the scheduled hourly total delivery is based on the peak forecasted power production for the renewable resource. For example, if 110 MW is a peak forecasted delivery rate for the first hour, then the schedule will commit to a total delivery and rate of delivery based on this forecast. In some embodiments, the scheduled hourly total delivery is based on other forecasted measures of power total power delivery or delivery rates from renewable resources.

At step 208, at the first hour on the accepted schedule, management system 101 sets the set point for the management system equal to the scheduled hourly total delivery for the first hour. At step 210, based at least on the set point and the forecasted renewable supply, management system 101 sets a central dispatch level to firming resource 113. For example, the scheduled hourly total delivery for the first hour is 110 MWh, and renewable resource 107 is forecasted to oscillate around a production rate of 100 MW, with a range of fluctuation in production rate between 90 MW and 110 MW. In this example, based on these values and based on the goal to minimize use of the firming resource 113, at step 210, management system 101 sets a central dispatch level of 10 MW to firming resource 113.

Steps 212-218 represent the execution of processes by management system 101 to provide real-time dispatch directives to firming resource 113 to produce stable combined production output 119. The steps, described in further detail in the following discussion, are repeated at short intervals throughout the first hour. In this example, the steps are repeated at 5 second intervals. However, the interval used can be any interval that is compatible with the profile and operational ranges of the firming resource. For example, a power production system 100 using one or more fast-acting firming resources may repeat steps 212-218 at intervals that are seconds apart. Power production systems 100 using slow-acting firming resources may use repeat steps 212-218 at intervals that are minutes apart.

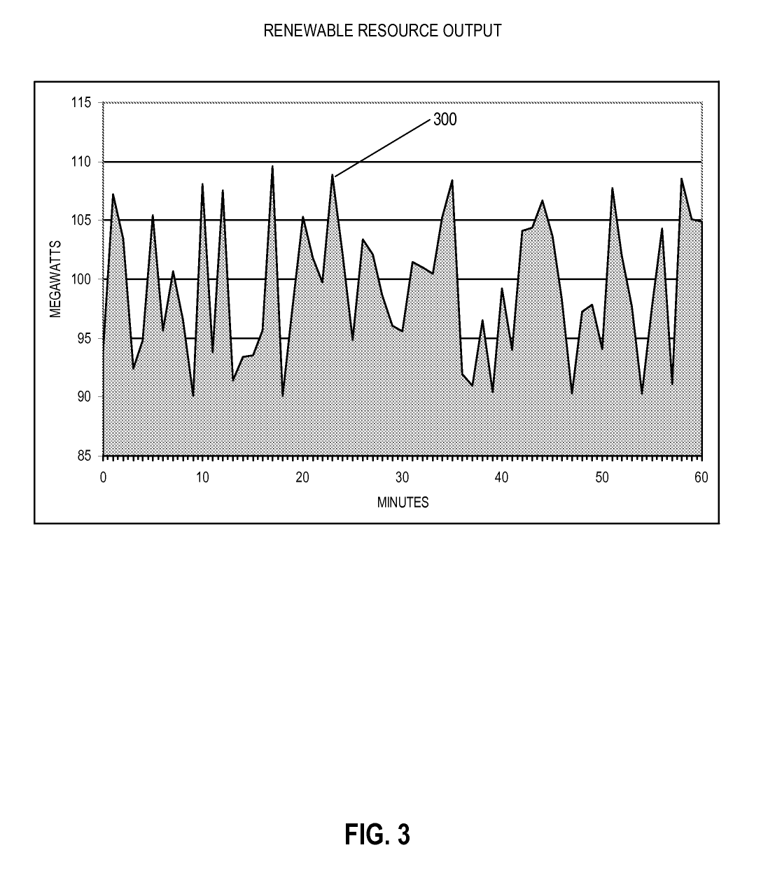

At step 212, management system 101 receives real-time renewable or variable generation data from renewable resource 107, for example, from wind- or solar-powered generating resources. FIG. 3 is a graph illustrating an example of the fluctuating output 300 from a renewable resource in an hour according to some embodiments of the invention. In the example hour illustrated in FIG. 3, the renewable resource produces power levels between 90 and 110 megawatts based on the level of wind, sunlight, or other variable natural energy source available to the renewable resource.

At step 214, management system 101 determines the difference between the set point and the actual combined production output 119. At step 216, management system 101 also considers the profile of the firming resource, the operational range of the firming resource, system frequency deviations, and other power system characteristics. For example, management system 101 considers the capabilities of firming resource 113 in order to not exceed any limitations of the resource, including but not limited to operational limits, ramp-rate, cost curves where applied, run time limits, permit emission limits and cycling limits, dead bands and time delays, among others. Based on steps 214 and 216, at step 218, management system 101 sends dispatch instructions to firming resource 113 to adjust the dispatch level from the central level.

In this example, steps 212-218 are repeated at 5-second intervals for the hour. At the end of the hour, management system 101 repeats the sequence starting at step 208 by setting the set point equal to the scheduled delivery for the next hour of the accepted schedule. The scheduled delivery for the next hour may be the same, higher, or lower than the previous hour.

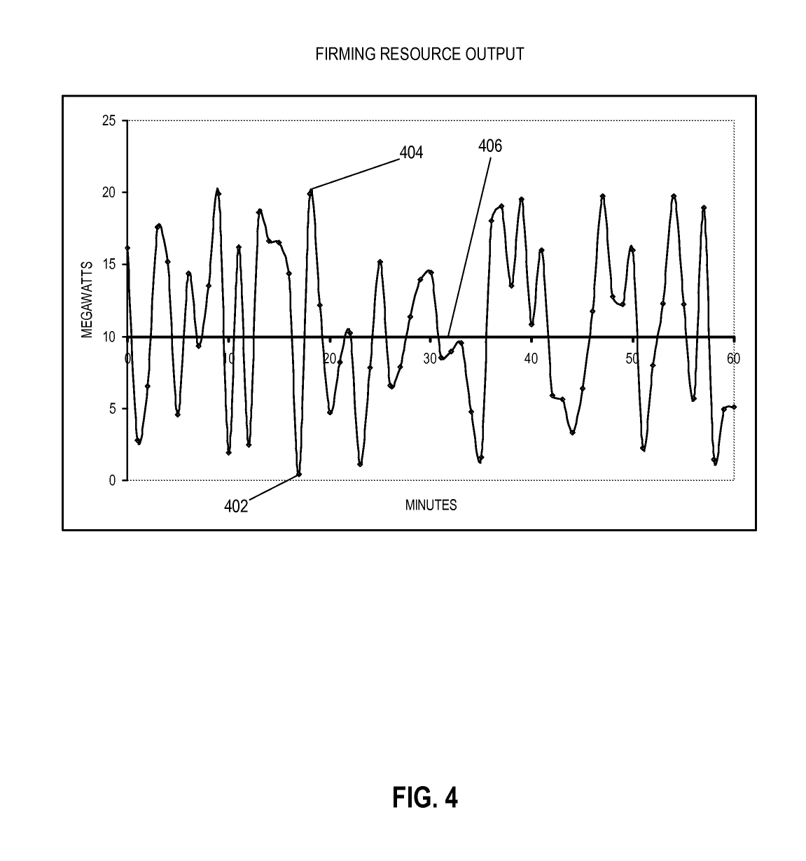

FIG. 4 is a graph illustrating an example of power production by firming resource 113 in response to dispatch instructions from management system 101, according to some embodiments of the invention. In this example, in response to a peak in production by renewable resource 107, the dispatch level of firming resource 113 is lowered to a level 402 close to zero, resulting in power production close to the scheduled level in spite of the peak. Similarly, in response to a drop in production from renewable resource 107, the dispatch level of firming resource 113 is increased to level 404. Central dispatch level 406 is set at the beginning of the hour such that the dispatch level of firming resource 113 is able to be increased or decreased according to the determinations made by management system 101 to produce stable combined production output 119. In a preferred embodiment, central dispatch level 406 is high enough to accommodate any necessary decrease in dispatch level without reaching a zero dispatch level.

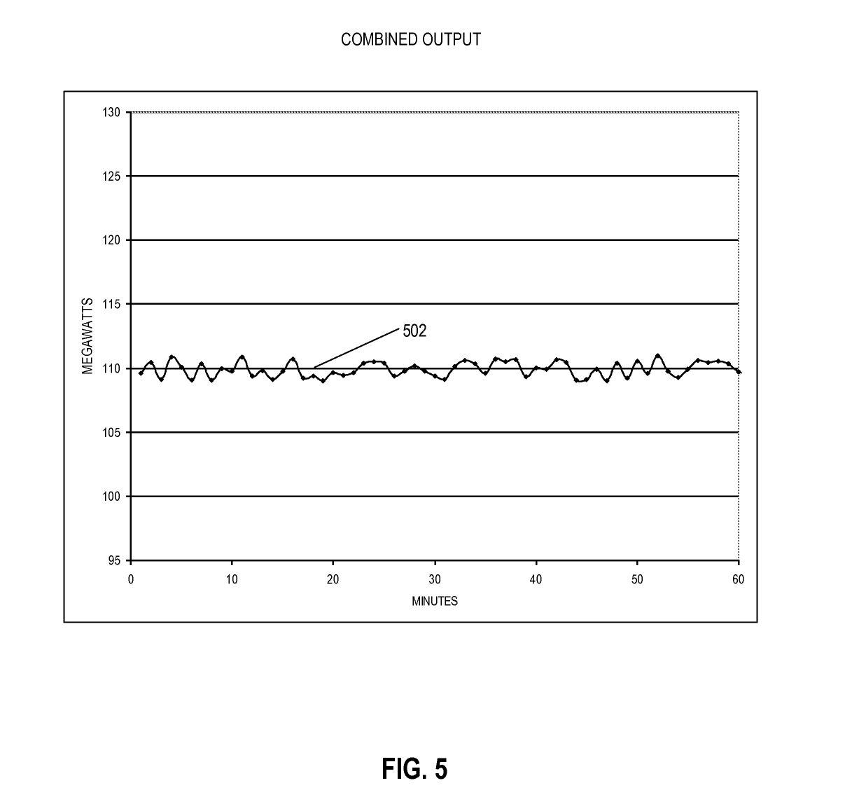

FIG. 5 is a graph illustrating an example of stable power production output by power production system 100 using one or more or the methods, steps, or processes described above, according to some embodiments of the invention. In particular, FIG. 5 is a possible result of the combined output of the processes described with reference to FIGS. 2-4 above. As illustrated, combined output from a renewable resource shown in FIG. 3 and a firming resource shown in FIG. 4 approximates a scheduled delivery of 110 MW over the hour. By producing a combined power output that is stable, that maximizes use of the renewable resource, and minimize use of the firming resource, generator operator is able to supply power that is predominately renewable-resource-produced to a grid operator while incurring as few financial penalties as possible from imbalance energy charges and uninstructed deviation penalties.

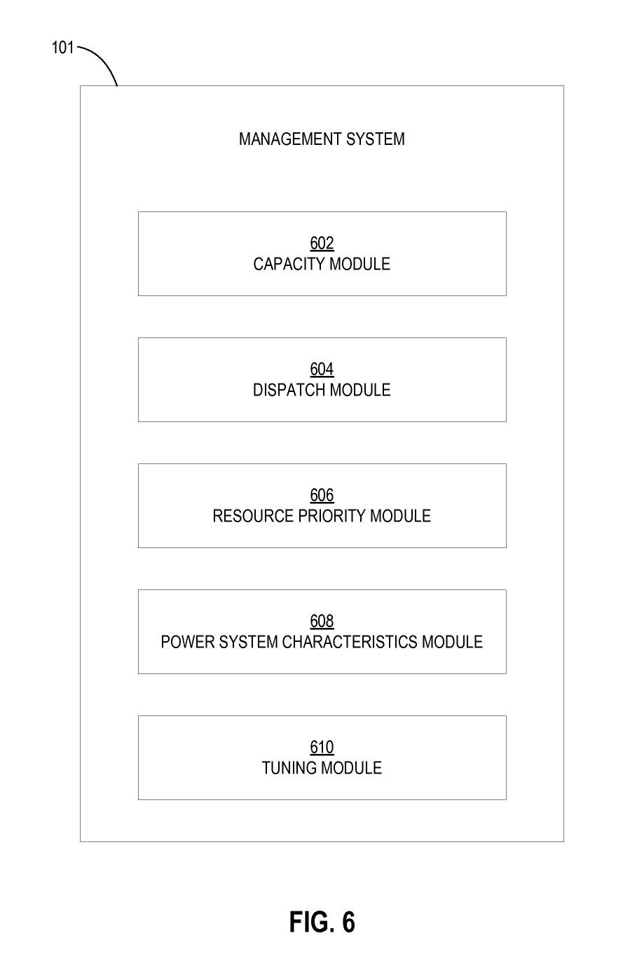

FIG. 6 is a block diagram illustrating the various modules of management system 101 according to some embodiments of the invention. In some embodiments of the invention, management system 101 is comprised of several unique modules, each of which utilizes historical, generator specific parameters, and scheduled and actual production real-time data (second by second) to calculate the necessary directive orders necessary to achieve coupled/combined stable resource output to the grid. While each module is described below as a discrete module, the functionality of the modules may be combined or separated into one or more different modules without departing from the spirit of the invention.

Capacity module 602 performs calculations to determine the planned hourly firming resource capacity requirement to accommodate the forward projection of production deviation of the renewable resources or supplies from the schedule. This computation will utilize both real-time as well as historical data to make the determination of projected deviation for each of the variable renewable supplies being managed. A capacity value for the firming resource will be accompanied by start and end times for the next approaching period of time on the schedule. Capacity module 602 will continuously calculate the firming resource capacity and other associated parameters seconds before the actual operating period. The purpose of capacity module 602 is to position the firming resource for its most efficient use during the upcoming schedule period. For example, capacity module 602 determines a central dispatch level for the firming resource at the start of each hour identified on the schedule.

Dispatch module 604 will continuously calculate the firming resource dispatch requirement for each forward time period and issue a dispatch command to the firming resource to achieve the objective combined resource production level. The command causes an increase or decrease in production level at the firming resource in proportional response to the amount of variability in the power generated at the renewable resource, within the capability of the firming resource. Dispatch module 604 continuously considers the operational limits, ramp-rate, cost curves where applied, run time limits, permit emission limits and cycling limits, dead bands and time delays among others, in determining dispatch commands.

Resource priority module 606 integrates and tracks the cumulative energy production hourly to achieve the scheduled hourly quantity (e.g., total MWh) of the combined resources. Resource priority module 606 also includes report tracking of the renewable output as compared to firming resource output, fuel utilized, cycles performed and other various metric data. Resource priority module 606 also monitors and maximizes the renewable resource production and minimizes the operation of the fossil-fuel-consuming firming resource. The module tracks any renewable curtailments that are operationally necessary to return the renewable supply to its scheduled output if it is generating above schedule. The features of this module will be to emphasize utilizing the firming resource's power generation in its most efficient manner while maximizing the capacity of the renewable resource. Additionally, this module functions to provide various information for the forecast of available renewable generation to generator operator and grid operator.

Power system characteristics module 608 increases the combined resource electrical frequency response characteristics (droop) and inertial effects of power production system 100 in order to replace these missing characteristics of the variable energy renewable sources. In some embodiments, power system characteristics module 608 is operatively coupled with a voltage regulator capable of operating in droop mode. In some embodiments, power system characteristics module 608 may override the frequency response of the voltage regulator.

Tuning module 610 adjusts numerous tunable parameters, including dead bands, time delays, operator manual controls, in order to achieve combined output 119 as desired and within a defined tolerance.

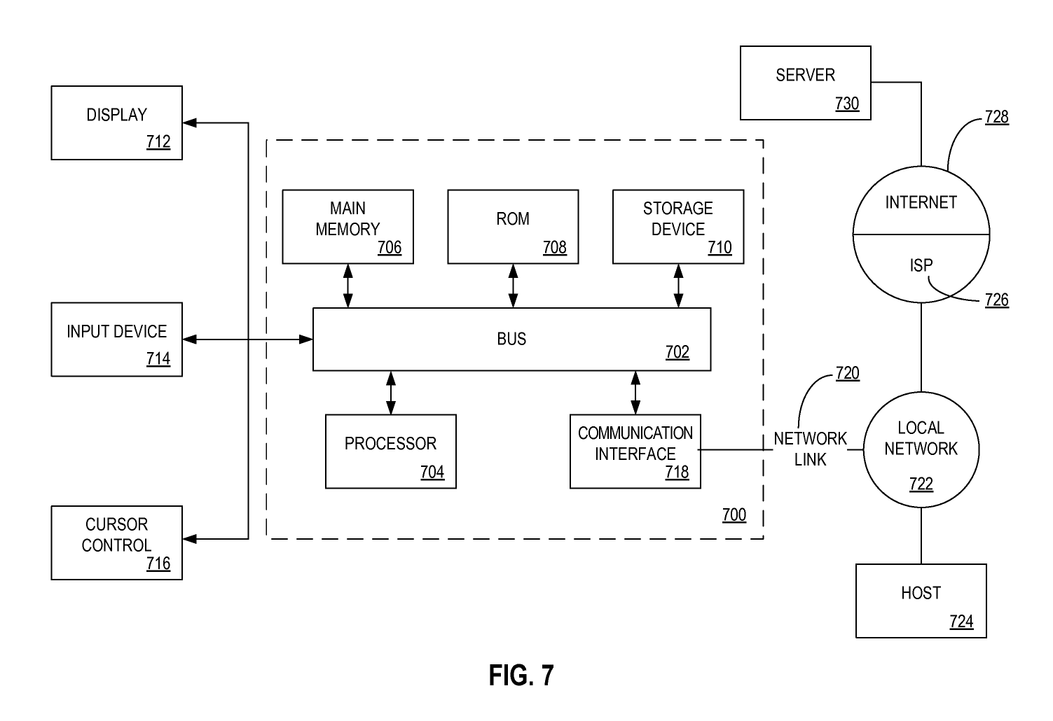

FIG. 7 is a block diagram that illustrates a computer system 700 upon which some embodiments of the invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT) or liquid crystal display (LCD), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. In some embodiments, input device 714 is integrated into display 712, such as a touchscreen display for communication command selection to processor 704. Another type of input device includes a video camera, a depth camera, or a 3D camera. Another type of input device includes a voice command input device, such as a microphone operatively coupled to speech interpretation module for communication command selection to processor 704.

The invention is related to the use of computer system 700 for implementing the techniques described herein. According to one embodiment of the invention, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software. In further embodiments, multiple computer systems 700 are operatively coupled to implement the embodiments in a distributed system.

The terms “machine-readable medium” as used herein refer to any medium that participates in providing data that causes a machine to operate in a specific fashion. In an embodiment implemented using computer system 700, various machine-readable media are involved, for example, in providing instructions to processor 704 for execution. Such a medium may take many forms, including but not limited to storage media and transmission media. Storage media includes both non-volatile media and volatile media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or other internet connection device, or a modem to provide a data communication connection to a corresponding type of telephone line. As another example, communication interface 718 may be a local area network (LAN) card to provide a data communication connection to a compatible LAN. Wireless network links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the Internet 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 710 might transmit a requested code for an application program through Internet 728, ISP 726, local network 722 and communication interface 718.

The received code may be executed by processor 704 as it is received, and/or stored in storage device 710, or other non-volatile storage for later execution. In this manner, computer system 700 may obtain application code in the form of a carrier wave.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising the steps of:
(a) operatively coupling a firming resource and a renewable resource in a unified power production system;
(b) determining a renewable resource forecast for the renewable resource;
(c) determining a set of operational values for the firming resource;
(d) identifying a setpoint of electrical power generation based on at least the renewable resource forecast and one or more values of the set of operational values for the firming resource;
(e) determining a first operational state for the firming resource based on at least the setpoint, the renewable resource forecast and one or more values of the set of operational values for the firming resource; and
(f) causing the firming resource to operate at the first operational state.

2. The method of claim 1, further comprising the steps of:
(g) determining electrical power generation level by the renewable resource for a current period;
(h) determining an adjustment of the first operational state for the firming resource based on at least the current electrical power generation level; and
(i) causing the firming resource to operate at a second operational state based on the adjustment.

3. The method of claim 2, wherein the step of determining the adjustment is based at least on or more one or more values of the set of operational values for the firming resource.

4. The method of claim 2, wherein the step of determining the adjustment comprises executing a proportional derivative control process.

5. The method of claim 2, further comprising:
performing steps (d)-(f) at the beginning of a next scheduled period.

6. The method of claim 5, further comprising:
performing steps (g)-(i) at regular intervals within the scheduled period.

7. The method of claim 6, wherein the intervals are shorter than 10 seconds.

8. The method of claim 1, further comprising the steps of:
causing electrical power generation by the renewable resource in combination with a power generation output from the firming resource to be delivered to a grid operator as a combined power delivery.

9. The method of claim 8, wherein the combined power delivery is more stable than the current electrical power generation by the renewable resource.

10. The method of claim 8, wherein the combined power delivery is within a particular range of the setpoint at one or more moments during the delivery.

11. The method of claim 8, wherein the power output from the firming resource is maintained at a minimum necessary level for producing a combined power delivery from the firming resource and the renewable resource that is stable.

12. The method of claim 1, further comprising:
determining one or more schedules based on the renewable resource forecast; and
wherein the step (d) of identifying the setpoint is based on at least the one or more schedules.

13. The method of claim 12, wherein the one or more schedules reflect a target combined power delivery for a scheduled period.

14. The method of claim 1, wherein the set of operational values for the firming resource includes any one or more of capacity and supply characteristics, operational deadband values, time-delay values, and directional turn-about values, capacity values, ramp-up speed, and ramp-down speed.

15. The method of claim 1, wherein the first operational state is a dispatch level for the firming resource.

16. The method of claim 1, wherein the firming resource is a dedicated firming resource for the unified power production system.

17. The method of claim 1, wherein the renewable resource is powered by sources including wind, solar, geothermal, or tidal.

18. The method of claim 1, wherein the firming resource is one of a reciprocating engine, fossil fuel generator, hydroelectric power, battery power, electrical storage facilities, demand response systems.

19. A system comprising one or more processors, and a computer-readable storage medium carrying one or more sequences of instructions, which when executed by the one or more processors implement a method comprising the steps of:
(a) operatively coupling a firming resource and a renewable resource in a unified power production system;
(b) determining a renewable resource forecast for the renewable resource;
(c) determining a set of operational values for the firming resource;
(d) identifying a setpoint of electrical power generation based on at least the renewable resource forecast and one or more values of the set of operational values for the firming resource;
(e) determining a first operational state for the firming resource based on at least the setpoint, the renewable resource forecast and one or more values of the set of operational values for the firming resource; and
(f) causing the firming resource to operate at the first operational state.

20. The system of claim 19, further comprising the steps of:
(g) determining electrical power generation level by the renewable resource for a current period;
(h) determining an adjustment of the first operational state for the firming resource based on at least the current electrical power generation level; and
(i) causing the firming resource to operate at a second operational state based on the adjustment.

21. The system of claim 20, wherein the step of determining the adjustment is based at least on or more one or more values of the set of operational values for the firming resource.

22. The system of claim 20, wherein the step of determining the adjustment comprises executing a proportional derivative control process.

23. The system of claim 20, further comprising:
performing steps (d)-(f) at the beginning of a next scheduled period.

24. The system of claim 23, further comprising:
performing steps (g)-(i) at regular intervals within the scheduled period.

25. The system of claim 24, wherein the intervals are shorter than 10 seconds.

26. The system of claim 19, further comprising the steps of:
causing electrical power generation by the renewable resource in combination with a power generation output from the firming resource to be delivered to a grid operator as a combined power delivery.

27. The system of claim 26, wherein the combined power delivery is more stable than the current electrical power generation by the renewable resource.

28. The system of claim 26, wherein the combined power delivery is within a particular range of the setpoint at one or more moments during the delivery.

29. The system of claim 26, wherein the power output from the firming resource is maintained at a minimum necessary level for producing a combined power delivery from the firming resource and the renewable resource that is stable.

30. The system of claim 19, further comprising:
determining one or more schedules based on the renewable resource forecast; and
wherein the step (d) of identifying the setpoint is based on at least the one or more schedules.

31. The system of claim 30, wherein the one or more schedules reflect a target combined power delivery for a scheduled period.

32. The system of claim 19, wherein the set of operational values for the firming resource includes any one or more of capacity and supply characteristics, operational deadband values, time-delay values, and directional turn-about values, capacity values, ramp-up speed, and ramp-down speed.

33. The system of claim 19, wherein the first operational state is a dispatch level for the firming resource.

34. The system of claim 19, wherein the firming resource is a dedicated firming resource for the unified power production system.

35. The system of claim 19, wherein the renewable resource is powered by sources including wind, solar, geothermal, or tidal.

36. The system of claim 19, wherein the firming resource is one of a reciprocating engine, fossil fuel generator, hydroelectric power, battery power, electrical storage facilities, demand response systems.
